(19) United States
(12) Patent Application Publication
(10) Pub. No.: US 2005/0207373 A1
(43) Pub. Date: Sep. 22, 2005

(54) Method and system for allocating time slots for a common control channel

(75) Inventors: Vincent Roy, Montreal (CA); Paul Marinier, Brossard (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/016,027

(22) Filed: Dec. 17, 2004

Related U.S. Application Data
(60) Provisional application No. 60/553,520, filed on Mar. 16, 2004.

(51) Int. Cl. H04Q 7/00; H04L 12/43

(52) U.S. Cl. 370/329; 370/458

(57) ABSTRACT

A method and system for allocating a time slot to each of the base stations for a communication channel to each of a plurality of base stations in a wireless communication system is disclosed. In a wireless communication system, a coverage area of the system is divided into a plurality of cells and each cell is served by a base station. The system receives a list of base stations which need to be configured along with a list of time slots available to transmit the communication channel. A time slot for the communication channel is allocated to each of the base stations in the list based on interference measured at each of the base stations in the list.

### CROSS REFERENCE TO RELATED APPLICATION

This application claims the benefit of U.S. Provisional Application No. 60/553,520 filed Mar. 16, 2004, which is incorporated by reference as if fully set forth.

### FIELD OF INVENTION

The present invention is related to a wireless communication system. More particularly, the present invention is a method and system for allocating time slots for a common control channel in a wireless communication system.

### BACKGROUND

Cellular systems typically use common control channels to carry control information to wireless transmit/receive units (WTRUs) in a cell or a set of cells. In time division duplex (TDD) systems, there are two types of Common Control Physical Channels (CCPCH): a Primary Common Control Physical Channel (PCCPCH), which supports a Broadcast Channel (BCH); and a Secondary Common Control Physical Channel (SCCPCH) that supports a Forward Access Channel (FACH) and a Paging Channel (PCH). PCCPCHs and SCCPCHs are typically supported by different time slots. The time slots used for the transmission of the PCCPCH or the SCCPCH may or may not be different from one cell to another.

When two cells belonging to the same subsystem use the same timeslot to transmit a CCPCH, a WTRU's reception of the CCPCH in one cell can be impaired to a certain extent by the interference created by the transmission of the CCPCH by the other cell. The terminology “subsystem” refers to a set of TDD cells that can interfere with each other because of their relative proximity. If the level of this co-channel interference is too high, severe performance degradation may occur for WTRUs served by the cell. Examples of impacts resulting from poor PCCPCH reception include delays in the users' access to a Radio Access Network (RAN), service holes and degradation of key radio resource management functions such as handoffs and power control. Similarly, poor performance on the SCCPCH could result in unacceptable delays in call setup times and reduced throughput when the SCCPCH is used to transmit user data.

In order to avoid this degradation, the system operator may decide to avoid having neighboring cells using same time slots for their CCPCHs. If cell A and cell B are two neighboring cells, the timeslot used for a CCPCH in cell A would typically not be used in cell B, or possibly it could be used for transmission of dedicated channels (DCHs) with certain limitations, such as limiting the transmission power on that time slot.

In order to ensure a minimum separation between two cells using the same time slot for a CCPCH, a fixed reuse pattern (FRP) may be applied. In a FRP, time slots are allocated according to a regular pattern depending on the position of the base stations. A FRP technique can be employed relatively easily as long as base stations are deployed according to a geometrically regular grid and propagation conditions are relatively homogeneous across the deployment area. This can be considered to be the case in certain classical macro-cellular deployments, although not in all scenarios.

Unfortunately, many situations exist where the conditions mentioned above are not satisfied. For example, in micro-cellular and indoor deployments, the irregularity of certain geographical features along with site acquisition problems is likely to prevent the deployment of base stations according to regular grids. In these same environments, the propagation conditions are not necessarily homogeneous. In the case of a street level micro-cellular environment, the propagation conditions between two cells that are on the same street are radically different from the propagation conditions between two cells that are on streets perpendicular from each other. Furthermore, even notwithstanding site acquisition issues and non-uniform propagation conditions, deploying micro-cells and pico-cells using a perfectly geometrical grid may be undesirable from a capacity point of view since the traffic is highly non-uniform in these environments.

In these situations, the FRP techniques simply cannot be used and the operator has to rely on trial and error for allocating proper time slots to CCPCHs. If this trial and error process is performed before commercial service launch, this process would require exhaustive field measurements. Alternatively, if this trial and error process is performed on a live network, it could result in poor quality perceived by the users until the proper settings are found.

In another alternative, the operator may use a radio frequency pathloss prediction tool prior to the trial and error process, but this also requires exhaustive field measurements and calibration. As a result, this process is costly and inefficient.

### SUMMARY

A method and system for allocating a time slot to each of the base stations for a communication channel is disclosed. In a wireless communication system, a coverage area of the system is divided into a plurality of cells and each cell is served by a base station. The system allocates time slots for a communication channel, such as a CCPCH, to each of the base stations in the list, based upon interference measured at each of the base stations in the list.

### BRIEF DESCRIPTION OF THE DRAWINGS

FIG. 1 is a wireless communication system in accordance with the present invention.

FIG. 2 is a flow diagram of a process for automatic time slot to cell allocation for a communication channel in accordance with the present invention.

### DETAILED DESCRIPTION OF THE PREFERRED EMBODIMENTS

The present invention will be described with reference to the drawing figures wherein like numerals represent like elements throughout.

Hereafter, the terminology “WTRU” includes but is not limited to a user equipment, a mobile station, a fixed or mobile subscriber unit, a pager, or any other type of device capable of operating in a wireless environment.

When referred to hereafter, the terminology “base station” includes but is not limited to a Node-B, a site controller, an access point or any other type of interfacing device in a wireless environment. Also, the term “CCPCH time slot” will be used to refer to any time slot that is used to transmit the CCPCH (either PCCPCH or SCCPCH).

The present invention is a system and a method that automatically and adaptively maps each base station in a wireless communication system to an appropriate CCPCH time slot. The method of the present invention can be implemented in a radio network controller (RNC) as an advanced function of the Radio Resource Management (RRM) function, or in a standalone software-planning tool. The present invention can be implemented to allocate radio resources to either the PCCPCH or SCCPCH time slots. For simplicity, the present invention will be described mainly with reference to the PCCPCH. However, it should be understood that the present invention could be used for self-configuration of any other CCPCH time slots, such as SCCPCH time slots. The invention may also be applied broadly to other types of time slots in any other communication channels.

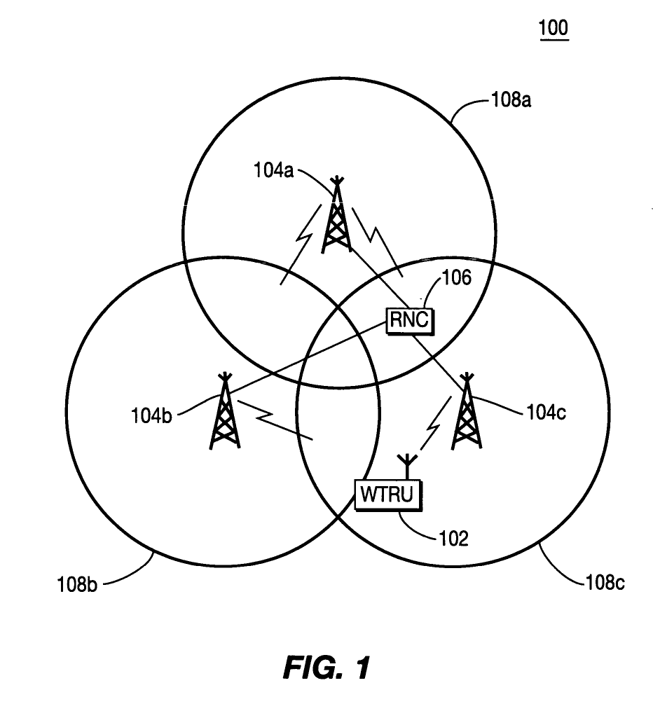

FIG. 1 shows a wireless communication system 100 in accordance with the present invention. The system 100 comprises a plurality of base stations 104a-c and a radio network controller (RNC) 106. The coverage area of the system 100 is divided into a plurality of cells 108a-c and each cell 108a-c is served by a separate base station 104a-c, respectively. The base stations 104a-c transmit system parameters, via a PCCPCH, which are necessary for enabling WTRUs, such a WTRU 102 to communicate with the base stations 104a-c. A list of the allowed time slots that can be allocated to the CCPCH is provided to the RNC 106.

In allocating the time slots for the CCPCH, the RNC 106 has access to a list of base stations 104a-c. The RNC 106 performs, in a sequential and iterative process, the CPCCH time slot-to-cell allocation of each base stations 104a-c in the list of base stations 104a-c. The slot-to-cell allocation is based on the interference measurements such that the interference level perceived at each base station 104a-c is minimized.

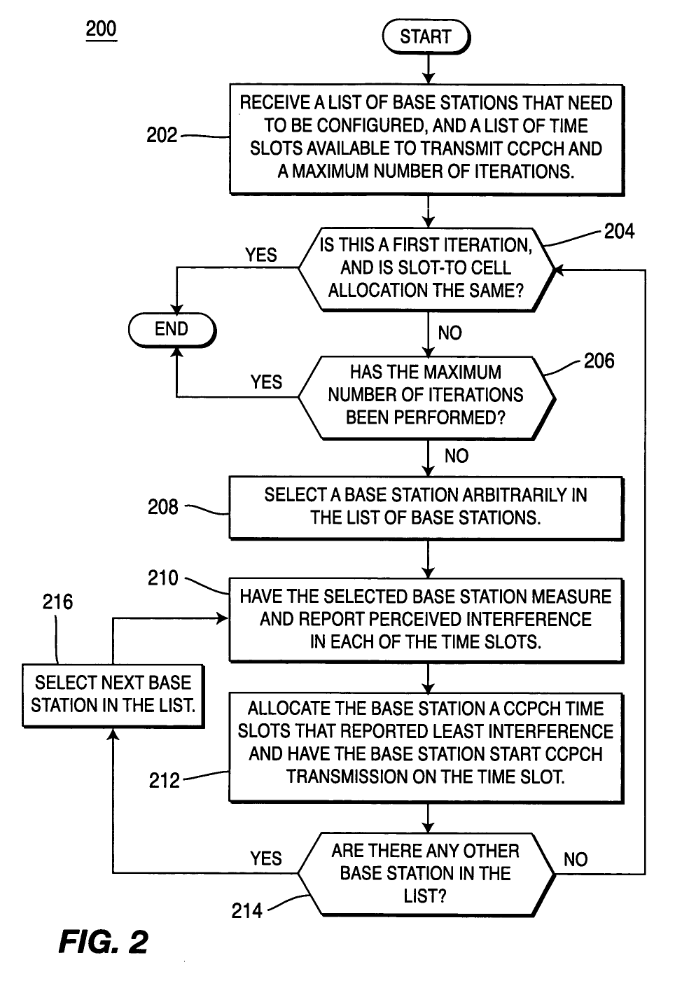

FIG. 2 is a flow diagram of a process 200 for allocating time slots in a wireless communication system in accordance with the present invention. The example used hereinafter will refer to a CCPCH. However, this is merely by way of example and not by limitation. It would be understood by those of skill in the art that other types of channels may implement the present invention. In the initial state, the base stations within a subsystem are deployed and are ready to be activated. None of the cells are assigned a PCCPCH timeslot. At this state, all the base stations in a subsystem are identified, and a list of base stations that need to be configured is provided as an input along with a list of time slots available to transmit CCPCH and a maximum number of iterations that the process 200 should perform (step 202).

In the case of an initial rollout of the system, the list of base stations would consist of all the cells in the system. In other scenarios, the list of base stations could include new base stations that have been deployed in an existing radio network or it could include a subset of the cells of a system for which optimization of the CCPCH time slot-to-cell allocation is needed. Prefreably, the list of base stations is provided by the wireless system operator as an input before triggering the automatic time slot-to-cell allocation.

The process 200 then allocates a time slot for a CCPCH to each of the base stations in the list based on interference measured at each of the base stations, as will be explained in detail hereinafter. The preferred mapping of CCPCH time slots to base stations is the one that yields the lowest interference in the CCPCH time slots as perceived by each base station.

The process 200 may be used to perform either full self-configuration or a partial self-configuration. Full self-configuration is a process performed on all the base stations in the system, which infers that the list of base stations received as an input in step 202 would include all base stations of the system. Partial self-configuration is a process performed when new cells are further deployed to an existing system as the radio network expands and it infers that the list of base stations received in step 202 would only include a subset of the base stations in the system. The process 200 may be used to perform either partial self-configuration or full self-configuration in order to obtain better performance on the PCCPCH.

The process 200 is an iterative process. At the beginning of every iteration, it determines if any of the two exit conditions are met (step 204 and 206). The first exit condition is that the timeslot-to-cell allocation of the current iteration did not change since the allocation at the previous iteration (step 204). This condition can only be met if the current iteration is not the first iteration that the process 200 is performing. If this first exit condition is met, the process terminates. If not, the process 200 further determines if the second exit condition is met, (i.e., whether the maximum number of iterations has been performed), (step 206). The maximum number of iterations is received as an input in step 202. If the maximum number of iterations have been performed, the process 200 terminates. Otherwise, the process 200 proceeds to step 208.

A first base station in the list of base stations is selected (step 208) and the first base station is triggered to measure and report the interference it perceives on each of the CCPCH time slots included in the list of available CCPCH time slots (step 210). It should be noted that the base stations are not required to be ranked in any particular order in the list of base stations. However, the base stations could be ranked according to their geographical coordinates, the date they have been deployed or any other criteria.

The first base station is allocated the CPCCH slot for which the measurement interference was the lowest, and the base station begins transmission of the CCPCH on the selected timeslot (step 212). In the case where multiple CCPCH slots have the same interference measurements, the first time slot in the list of allowed CCPCH time slots is selected.

It is then determined whether there are any other base stations remaining in the list (step 214). If there are no other base stations remaining in the list, the process 200 returns to step 204. If there is a remaining base station, the process 200 selects the next base station in the list of base stations (step 216), and proceeds to step 210.

The process 200 continues to implement steps 210-216 for all the remaining base stations in the list in the same manner and allocates appropriate PCCPCH time slots for each base station.

By allowing a wireless communication system to self-configure its allocation of PCCPCH slots to base stations, the present invention relieves the operator from the burden of pre-planning and allocating radio resources for the PCCPCH including the extensive field measurements campaign and the use of complex interference prediction tool when the system is deployed or augmented.

Although the features and elements of the present invention are described in the preferred embodiments in particular combinations, each feature or element can be used alone without the other features and elements of the preferred embodiments or in various combinations with or without other features and elements of the present invention.

1. In a wireless communication system where a coverage area of the system is divided by a plurality of cells and each cell is served by a base station, a method for dynamically allocating a time slot to each of the base stations for a common control physical channel (CCPCH) comprising:
(a) receiving as an input a list of base stations which need to be configured along with a list of time slots available to transmit the CCPCH; and
(b) automatically allocating a time slot for the CCPCH to each of the base stations in the list based on interference measured at each of the base stations in the list.

2. The method of claim 1 wherein the step (b) comprises:
(c) selecting a base station from the list of base stations;
(d) having the selected base station measure and report perceived interference in each time slot available for the selected base station;
(e) allocating a time slot with the lowest interference to the selected base station; and
(f) repeating steps (c)-(e) for the remaining base stations in the list of base stations.

3. The method of claim 1 wherein the CCPCH is a primary CCPCH.

4. The method of claim 1 wherein the CCPCH is a secondary CCPCH.

5. The method of claim 1 wherein the base stations in the list of base stations are ranked in accordance with geographical coordinates of the base station.

6. The method of claim 1 wherein the base stations in the list of base stations are ranked in accordance with the date of deployment of the base station.

7. A radio network controller (RNC) for allocating a time slot to a base station for a common control physical channel (CCPCH) in a wireless communication system where a coverage area of the system is divided by a plurality of cells and each cell is served by a base station, the RNC comprising:
means for receiving as an input a list of base stations which need to be configured along with a list of time slots available to transmit CCPCH; and
means for allocating a time slot for a CCPCH to each of the base stations in the list based on interference measured at each of the base stations in the list.

8. The RNC of claim 7 wherein the allocating means comprises:
means for selecting a base station from the list of base stations;
means for selecting a time slot among allowed time slots for each base station;
means for requesting a base station to measure and report interference perceived at each time slot allowed for each base station; and
means for allocating a time slot with lowest interference to each base station.

9. The RNC of claim 7 wherein the CCPCH is a primary CCPCH.

10. The RNC of claim 7 wherein the CCPCH is a secondary CCPCH.

11. The RNC of claim 7 wherein the base stations in the list of base stations are ranked in accordance with geographical coordinates of the base station.

12. The RNC of claim 7 wherein the base stations in the list of base stations are ranked in accordance with the date of deployment of the base station.

13. In a wireless communication system having a plurality of cells, each cell being served by a base station, a method for dynamically allocating a time slot to each of the base stations for a communication channel comprising:
(a) receiving a list of base stations which need to be configured;
(b) receiving a list of time slots available to transmit the communication channel; and
(c) automatically allocating a time slot for the communication channel to each of the base stations in the list based on interference measured at each of the base stations in the list.

14. The method of claim 13 wherein the step (c) comprises:
(d) selecting a base station from the list of base stations;
(e) having the selected base station measure and report perceived interference in each time slot available for the selected base station;
(f) allocating a time slot with the lowest interference to the selected base station; and
(g) repeating steps (d)-(f) for the remaining base stations in the list of base stations.

15. The method of claim 13 wherein the base stations in the list of base stations are ranked in accordance with geographical coordinates of the base station.

16. The method of claim 13 wherein the base stations in the list of base stations are ranked in accordance with the date of deployment of the base station.
